(19) United States
(12) Patent Application Publication
(10) Pub. No.: US 2007/0245630 A1
(43) Pub. Date: Oct. 25, 2007

(54) Method for generating carbon monoxide from synthesis gas

(76) Inventors: Harald Klein, Wolfratshausen (DE); Martin Lang, Munchen (DE); Pavel Masek, Munchen (DE)

Correspondence Address: MILLEN, WHITE, ZELANO & BRANIGAN, P.C.;Arlington Courthouse Plaza 1, Suite 1400, 2200 Clarendon Blvd., Arlington, VA, 22201, US

(21) Appl. No.: 11/704,386

(22) Filed: Feb. 9, 2007

(30) Foreign Application Priority Data
Feb. 10, 2006 (DE) 10 2006 006281.7

(51) Int. Cl. C01B 3/24

(52) U.S. Cl. 48/198.3

(57) ABSTRACT

Carbon monoxide is generated carbon monoxide, in a conversion stage (DR), from a hydrocarbon-containing feed (1, 2), and also steam and/or carbon dioxide (CO₂), resulting in the formation of a carbon monoxide (CO)—, hydrogen (H₂)— and methane (CH₄)-containing synthesis gas (3). The synthesis gas is subsequently fed to a fractionation device (Z) for separating off at least one hydrogen-rich fraction (7, 9) and one methane-rich fraction (10) and also a carbon monoxide product (6). The methane-rich fraction (10) separated off in the fractionation device (Z) is recirculated as feed (M feed) upstream of the conversion stage (DR).

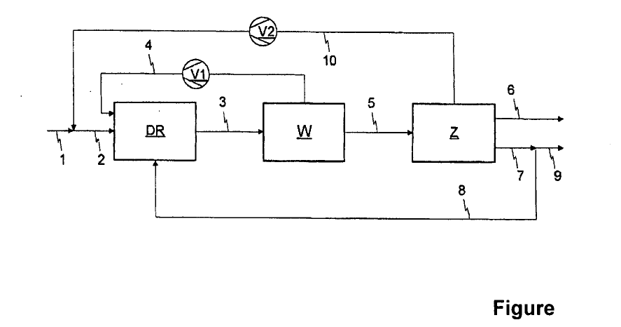

The invention relates to a method for generating carbon monoxide, in a conversion stage, from a hydrocarbon-containing feed and also steam and/or carbon dioxide (CO₂), a carbon monoxide (CO)—, hydrogen (H₂)— and methane (CH₄)-containing synthesis gas being generated which is subsequently fed to a fractionation device for separating off at least one hydrogen-rich fraction and one methane-rich fraction and also a carbon monoxide product.

In addition to hydrogen (H₂), carbon monoxide (CO) is the smallest reactive building block for the synthesis of organic chemicals, in particular of many industrially produced products. Raw material sources of CO are synthesis gases as are formed in the gasification of anthracite, the low-temperature carbonization of brown coal, or the cracking of hydrocarbons by means of steam and/or carbon dioxide (CO₂). To obtain a CO product, the materials present in addition to CO in a synthesis gas such as, for example, H₂, CO₂ or methane (CH₄) are separated off from the CO in a fractionation device and preferably fed to an economic use.

If the CO-containing synthesis gas is produced by cracking light hydrocarbons, in addition to carbon monoxide, it also contains relatively large amounts of hydrogen. Particularly when the light hydrocarbons are subjected to catalytic steam reforming, the ratio of hydrogen to carbon monoxide (H₂/CO ratio) in the synthesis gas is high, and can reach a value of 3 when the light hydrocarbons are natural gas.

If it is not possible to feed the hydrogen generated as by-product in the CO production to an economic use, in the prior art, the carbon dioxide scrubbed out of the synthesis gas is recirculated upstream of the steam reformer where it replaces at least a part of the required steam. As a result, based on the following equation, the reaction equilibrium is shifted in the direction of carbon monoxide:
CO₂+H₂ [symbol] CO+H₂O
and the H₂/CO ratio can be reduced to approximately 2.5. If it is not possible to feed further carbon dioxide to the process from outside boundaries of the installation, an economically utilizable product must be produced form the hydrogen formed, since otherwise the overall economy of the method is put into question. If it is not possible to use the hydrogen in other ways (for example for synthesis purposes), in the prior art it is used as fuel, for example for firing the steam reformer.

It is likewise known to use the methane separated off from the synthesis gas for firing the steam reformer. Since less hydrogen is required for bottom firing in the steam reformer, the H₂/CO ratio at the boundary of the installation, increases, however, and therefore also the amount of hydrogen which must be released as by-product.

### SUMMARY OF INVENTION

Therefore, an object of the present invention is to provide a method of the type described above in which the amount of hydrogen produced as by-product is decreased compared with the prior art and the economic efficiency of carbon monoxide generation is increased.

Upon further study of the specification and appended claims, further objects, aspects and advantages of this invention will become apparent to those skilled in the art.

These objects can be achieved according to the invention by feeding a methane-rich fraction (M feed) separated off in the fractionation device to the conversion stage at a suitable point.

If natural gas is fed to the conversion stage as hydrocarbon-containing feed, the M feed can be expediently mixed with the natural gas feed, passed on together with this and reacted to form synthesis gas.

If the pressure of the feed materials entering into the conversion stage is higher than the pressure of the methane-rich fraction exiting from the fractionation unit, it is necessary to increase the pressure of the methane-rich fraction in order to be able to recirculate it as M feed upstream of the conversion stage. Thus, according to an embodiment of the inventive method, a pressure increase of the methane-rich fraction that may be needed for recycling the methane fraction is carried out by means of a separate methane recycle compressor.

In order to increase the CO yield, CO₂ separated off from the synthesis gas by means of a CO₂ recycle compressor can be recirculated to a point upstream of the conversion stage. Another embodiment of the inventive method provides for adding a methane-rich fraction from the fractionation part to the CO₂ stream. The combined streams can then be compressed together in the CO₂ recycle compressor, and recirculated as M feed upstream of the conversion stage.

A variant of the method according to the invention provides a cryogenic methane wash unit, which are known from the prior art, as a fractionation device for separating off the CO product from the synthesis gas. Typically, a methane wash unit comprises three columns. In a first column, the CH₄ scrubbing column, CO is removed from the H₂ fraction by scrubbing with liquid CH₄. In a second column, an H₂ stripper column, residual H₂ is stripped from the CO/CH₄-rich liquid removed from the bottom of the CH₄ scrubbing column. In the third column, the CO/CH₄ mixture removed from the second column is subjected to rectification. The gaseous product from the third column is CO, whereas the liquid bottom product is CH₄. Liquid CH₄ from the bottom of the third column can then be pumped, sub-cooled, and then used as reflux the first and second columns to thereby form a CH₄ cycle.

In the methane wash unit used in accordance with the invention, methane present in the synthesis gas can be separated off by rectification and used as scrubbing medium for the CH₄ scrubbing column. For this the liquid CH₄ is brought to the desired pressure using a pump. Expediently, at least a part of the excess CH₄ is vaporized under pressure, warmed and recirculated as M feed upstream of the conversion stage. The pressure increase is selected in this case to be of a size such that a sufficient pressure drop is available for recycling. A methane recycle compressor can be omitted in this method variant. To increase the solubility of the synthesis gas with respect to trace components during cooling and condensation, an embodiment of this method variant provides that a small part of the CH₄ fraction produced under pressure is recirculated to a point upstream of the fractionation device and introduced into the synthesis gas.

The omission of the methane-rich fraction from the fractionation device as fuel, for example for firing a steam reformer used as the conversion stage, according to the invention, is compensated by at least a part of the excess amount of the hydrogen fraction separated from the synthesis gas in the fractionation device. As a result, the amount of hydrogen to be released at the at the boundary of the installation decreases. Expediently, raw hydrogen, that is hydrogen which is not of product quality, can be used instead of the methane-rich fraction as fuel.

By recycling a methane-rich fraction from the fractionation unit as M feed to a point upstream of the conversion stage, less hydrocarbon-containing feed is required, compared with the prior art, to generate a predetermined amount of carbon monoxide product. This fact may be demonstrated in the example of a plant for the production of 10 000 m_{N}³/h carbon monoxide, in which natural gas is reacted in an externally-fired steam reformer to form synthesis gas. The amount of hydrogen separated off in the fractionation device is termed crude H₂ in the table. All data in the table are to be understood as flow rates in m_{N}³/h.

| | | | Max. crude H₂ |
|---|---|---|---|
| | | Max. | used as |
| | Crude H₂ not | crude H₂ | fuel; CH₄ |
| | used as fuel | used as fuel | recycle |
| Natural gas | 11 084 | 11 084 | 9 195 |
| as feed | | | |
| Crude H₂ | 29 177 | 16 089 | 9 718 |
| Natural gas | 2 318 | 0 | 0 |
| as fuel | | | |
| Crude H₂ as | 0 | 12 745 | 19 828 |
| fuel | | | |

It can be seen from the table that recycling the methane-rich fraction from the fractionation unit as M feed to the steam reformer, in addition to increasing the amount of hydrogen maximally usable for firing the steam reformer also causes a considerable saving of natural gas feed. As a result of both effects, the economic efficiency of carbon monoxide production is significantly increased.

Although in the production of carbon monoxide the reaction of the light hydrocarbons generally proceeds without air, substances such as nitrogen and argon pass via the hydrocarbon-containing feeds into the synthesis gas and finally also into the CO product. In order to achieve the desired CO product purity, in this case generally expenditure on apparatus and on energy is required which increases disproportionately for the sought-after purity. Therefore, frequently, the nitrogen/argon removal is omitted and a lower purity of the CO product is accepted, which is then determined by the height of the nitrogen and argon fractions in the hydrocarbon-containing feed.

Compared with the prior art, when the method of the invention is used, less nitrogen and argon are introduced into the process, since, as M feed upstream of the conversion stage, recirculated methane is generally low in nitrogen and argon. For this reason, purity of the CO product increases by 0.5 to 1%, even without the use of special methods for separating off nitrogen and argon from the CO product.

Hereinafter, the invention will be described in more detail on the basis of an example shown diagrammatically in the figure.

The entire disclosures of all applications, patents and publications, cited above and below, are hereby incorporated by reference.

### BRIEF DESCRIPTION OF THE DRAWINGS

Various other features and attendant advantages of the present invention will be more fully appreciated as the same becomes better understood when considered in conjunction with the accompanying drawing wherein: the drawing illustrates an embodiment of the invention.

### DETAILED DESCRIPTION

The present example relates to a plant in which a carbon monoxide product is produced from a methane-containing feed (natural gas) by steam cracking in an externally-fired steam reformer and subsequent cryogenic separation.

Via the lines 1, 2, natural gas which is free from interfering impurities (for example hydrogen sulphide) in preceding steps (not shown) and is mixed with steam, is introduced into the steam reformer DR. In the steam reformer DR, from the feed a synthesis gas is formed which, in addition to carbon monoxide, hydrogen and methane, also contains carbon dioxide and water, and which is passed on to the carbon dioxide wash unit W via line 3. In the carbon dioxide wash unit W the synthesis gas is substantially purified from carbon dioxide. The carbon dioxide separated off from the synthesis gas in the carbon dioxide wash unit W is recirculated via line 4 and compressor V1 and introduced into the steam reformer DR which causes an increase of the carbon monoxide fraction in the synthesis gas 3. From the carbon dioxide wash unit W, the synthesis gas freed from carbon dioxide is passed via line 5 into the cryogenic fractionation unit Z, where, from the synthesis gas, in addition to a carbon monoxide product, which is passed on via line 6, a hydrogen-rich 7 and a methane-rich fraction 10 are also produced. A part of the hydrogen-rich fraction 7 is passed on via line 9, while another part 8 is passed to the steam reformer DR as fuel and there covers all of the requirements for heating energy. The methane-rich fraction 10 is recirculated by means of the compressor V2 upstream of the steam reformer DR and introduced into the steam reformer DR via line 2 together with the natural gas/steam mixture 1.

The entire disclosures of all applications, patents and publications, cited herein and of corresponding German application No. DE 102006006281.7, filed Feb. 10, 2006, are incorporated by reference herein.

The preceding example can be repeated with similar success by substituting the generically or specifically described reactants and/or operating conditions of this invention for those used in the preceding examples.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

1. A method for generating carbon monoxide, in a conversion stage, said method comprising:
introducing a hydrocarbon-containing feed, and steam, carbon dioxide (CO₂), or a combination of steam and carbon dioxide to said conversion stage;
generating in said conversion stage a carbon monoxide (CO)—, hydrogen (H₂)— and methane (CH₄)-containing synthesis gas, and feeding said synthesis gas to a fractionation device;
removing from said fraction a device at least one hydrogen-rich fraction (7), at least one methane-rich fraction (10), and a carbon monoxide product; and
recycling at least a portion of said methane-rich fraction (10) separated off in the fractionation device (Z) as feed (M feed) to said conversion stage (DR).

2. A method according to claim 1, wherein CO₂ (4) is removed from said synthesis gas (3) and recirculated by means of a CO₂ recycle compressor (V1) to a point upstream of said conversion stage (DR).

3. A method according to claim 1, wherein monoxide product (6) is separated from said synthesis gas (5) in a methane scrubber.

4. A method according to claim 1, wherein recirculation of methane fraction (10) to a point upstream of the conversion stage (DR) is carried out by means of a methane recycle compressor (V2).

5. A method according to claim 2, wherein said at least a portion of said methane fraction (10) to a point upstream of the conversion stage (DR) is carried out by means of said CO₂ recycle compressor (V1).

6. A method according to claim 3, at least a portion of excess liquid methane is vaporized within said methane scrubber by supply of heat and under pressure and is recirculated as M feed (10) upstream of the conversion stage (DR), the pressure increase being of a size such that solely on account of the pressure drop building up the M feed (10) flows back to the inlet side of the conversion stage (DR).

7. A method according to claim 1, said conversion stage is an externally-fired conversion stage (DR).

8. A method according to claim 1, wherein at least a part (8) of the hydrogen-rich fraction (7) is recirculated to the conversion stage (DR) from the fractionation device (Z).
